(19) United States
(12) Patent Application Publication
(10) Pub. No.: US 2024/0194030 A1
(43) Pub. Date: Jun. 13, 2024

(54) SERVICE PROVIDING SERVER FOR PROVIDING TOURNAMENT GAME SERVICE USING NFT AND THE OPERATING METHOD THEREOF

(71) Applicant: Supertree Co., Ltd., Seoul (KR)

(72) Inventor: Sung Wone CHOI, Seoul (KR)

(73) Assignee: Supertree Co., Ltd., Seoul (KR)

(21) Appl. No.: 18/523,932

(22) Filed: Nov. 30, 2023

(30) Foreign Application Priority Data
Dec. 7, 2022 (KR) 10-2022-0169392

(51) Int. Cl. G07F 17/32

(52) U.S. Cl. CPC G07F 17/3276; G07F 17/3241; G07F 17/3288

(57) ABSTRACT

Disclosed are a service providing server providing a tournament game service using a non-fungible token (NFT), and the operating method thereof to support users to enjoy a game while competing by a tournament scheme jointly with other users in an online environment.

### CROSS-REFERENCE TO RELATED APPLICATIONS

This application claims priority to and the benefit of Korean Patent Application No. 10-2022-0169392 filed in the Korean Intellectual Property Office on Dec. 7, 2022, the entire contents of which are incorporated herein by reference.

### TECHNICAL FIELD

The present disclosure relates to a service providing server for providing a tournament game service using NFT and the operating method thereof.

### BACKGROUND ART

Recently, as various electronic terminals including desktop PCs, smart phones, tablet PCs, console game machines, etc., have been released, the number of persons who play games through the electronic terminals has increased.

In particular, the recent electronic terminals provide an environment which enables playing games with others, in that the electronic terminals enable online connections.

As such, as the environment to play the games with other persons online has widely spread, an interest in the introduction of a new business model using online-based games is also increasing.

Normally, the online-based games are designed to allow people to compete with each other in an online environment, so it is possible to introduce a predetermined tournament service using the online-based games.

For example, by holding a tournament competition using a number of games so that people participate in the tournament of the game they want, the introduction of a business model that pays a certain reward to the winner who wins a specific tournament competition can be considered.

However, in order to provide a tournament platform service using these games, user management technology needs to be introduced, which does not allow anybody to participate in the tournament, but allows only the users who qualify for participating in a predetermined tournament to participate in the tournament to improve the quality of the service.

In this regard, the introduction of service technology can be considered, which allows only predetermined certified members to participate in the tournament, and at the same time, issues a predetermined ticket for participating in the tournament, and allows only the people who purchase this ticket to participate in the tournament of a specific game.

As the use of an NFT has increased recently, it is possible to use the method of issuing and managing a profile of a user who participates in the tournament as the NFT. Here, the NFT which means a ‘non-fungible token’ means a virtual asset that is impossible to replace each token with another token because a unique value is given to each token, and the NFT has an advantage of ensuring excellent reliability, and easily providing uniqueness and ownership of contents. In this regard, by including information on the number of holding tickets to participate in the tournament on the NFT of each user, the information is managed through a blockchain to introduce a service which enables more reliable verification of the user's qualifications to participate in the tournament.

### SUMMARY OF THE INVENTION

The present disclosure has been made in an effort to support users to enjoy a game while competing by a tournament scheme jointly with other users in an online environment by presenting a service providing server providing a tournament game service using a non-fungible token (NFT), and the operating method thereof.

An exemplary embodiment of the present disclosure provides a service providing server providing a tournament game service using a non-fungible token (NFT), which includes: a game information storage unit storing information on the number of required tickets for participating in tournaments of a plurality of predetermined respective games; a price information storage unit storing purchase price information of the ticket for participating in the tournament; an NFT generation unit requesting, when a new user registration request command for using the tournament game service is received from a first electronic terminal of a first user, transmission of identification information for identifying the first user to the first electronic terminal, and generating, when first user identification information is received from the first electronic terminal, a first NFT including the first user identification information as owner information; a registration processing unit registering and processing, when the first NFT is generated, the first NFT in a predetermined blockchain network for registering the NFT, and completing issuing the first NFT to complete new user registration; a completion message transmission unit generating, when issuing the first NFT is completed, a registration completion message indicating that issuing the first NFT is completed and at the same time, indicating that the new user registration is completed, and transmitting the registration completion message to the first electronic terminal; a payment processing unit requesting, upon receiving the purchase request command of requesting purchasing tickets as many as a first purchase quantity from the first electronic terminal after the issuance of the first NFT is completed, transmission of payment means information to the first electronic terminal, and calculating, upon receiving first payment means information from the first electronic terminal, a price corresponding to the first purchase quantity based on the purchase price information stored in the price information storage unit, and then performing payment processing for the calculated price based on the first payment means information; and a quantity processing unit generating, when the payment processing is completed, a first transaction indicting that the first user possesses tickets of the first purchase quantity, and registering and processing the first transaction in the blockchain network to process the first purchase quantity to be recorded in the first NFT registered in the blockchain network as information on a ticket holding quantity of the first user.

Another exemplary embodiment of the present disclosure provides an operating method of a service providing server providing a tournament game service using a non-fungible token (NFT), which includes: maintaining a game information storage unit storing information on the number of required tickets for participating in tournaments of a plurality of predetermined respective games; maintaining a price information storage unit storing purchase price information of the ticket for participating in the tournament; requesting, when a new user registration request command for using the tournament game service is received from a first electronic terminal of a first user, transmission of identification information for identifying the first user to the first electronic terminal, and generating, when first user identification information is received from the first electronic terminal, a first NFT including the first user identification information as owner information; registering and processing, when the first NFT is generated, the first NFT in a predetermined blockchain network for registering the NFT, and completing issuing the first NFT to complete new user registration; generating, when issuing the first NFT is completed, a registration completion message indicating that issuing the first NFT is completed and at the same time, indicating that the new user registration is completed, and transmitting the registration completion message to the first electronic terminal; requesting, upon receiving the purchase request command of requesting purchasing tickets as many as a first purchase quantity from the first electronic terminal after the issuance of the first NFT is completed, transmission of payment means information to the first electronic terminal, and calculating, upon receiving first payment means information from the first electronic terminal, a price corresponding to the first purchase quantity based on the purchase price information stored in the price information storage unit, and then performing payment processing for the calculated price based on the first payment means information; and generating, when the payment processing is completed, a first transaction indicting that the first user possesses tickets of the first purchase quantity, and registering and processing the first transaction in the blockchain network to process the first purchase quantity to be recorded in the first NFT registered in the blockchain network as information on a ticket holding quantity of the first user.

According to exemplary embodiments of the present disclosure, it is possible to support users to enjoy a game while competing the game by a tournament scheme jointly with other users in an online environment by presenting a service providing server providing a tournament game service using a non-fungible token (NFT), and the operating method thereof.

### BRIEF DESCRIPTION OF THE DRAWINGS

FIG. 1 is a diagram illustrating a structure of a service providing server providing a tournament game service using an NFT according to an exemplary embodiment of the present disclosure.

FIG. 2 is a diagram for describing an operation of a service providing server providing a tournament game service using an NFT according to an exemplary embodiment of the present disclosure.

FIG. 3 is a flowchart illustrating an operating method of a service providing server providing a tournament game service using an NFT according to an exemplary embodiment of the present disclosure.

### DETAILED DESCRIPTION

Hereinafter, exemplary embodiments of the present disclosure will be described in detail with reference to the accompanying drawings. The description does not limit the present disclosure to specific exemplary embodiments, and it should be understood that the present disclosure covers all the modifications, equivalents and replacements included within the idea and technical scope of the present disclosure. In describing each drawing, like reference numerals refer to like elements and if not contrarily defined, all terms used herein including technological or scientific terms have the same meanings as those generally understood by a person with ordinary skill in the art.

In this document, unless explicitly described to the contrary, the word “comprise” and variations such as “comprises” or “comprising”, will be understood to imply the inclusion of stated elements but not the exclusion of any other elements. Further, in various exemplary embodiments of the present disclosure, each of the components, functional blocks or means may be constituted by one or more lower components and electrical, electronic, and mechanical functions performed by respective components may be implemented as various known devices or mechanical elements including an electronic circuit, an integrated circuit, an Application Specific Integrated Circuit (ASIC), etc., and the respective components may be separately implemented or two or more components may be integrated into one and implemented.

Meanwhile, blocks of the accompanying block diagram or steps of a flowchart may be appreciated as meaning computer program instructions mounted on a processor or a memory of data processible equipment such as a universal computer, a special computer, a portable notebook computer, a network computer, etc., and performing designated functions. Since the computer program instructions may be stored in a memory provided in a computer device or a computer readable memory, functions described in blocks of a block diagram or steps of a flowchart may be produced as a manufactured object including an instruction mean performing the functions. Moreover, each block or each step may represent a part of a module, a segment, or a code that includes one or more executable instructions for executing a specified logical function(s). It should also be noted that in some replaceable embodiments, the functions mentioned in the blocks or steps may also be executed differently from a predetermined order. For example, two blocks or steps that are subsequently illustrated are substantially simultaneously carried out, or may be performed in a reverse order, and in some cases, the functions may be performed while some blocks or steps are omitted.

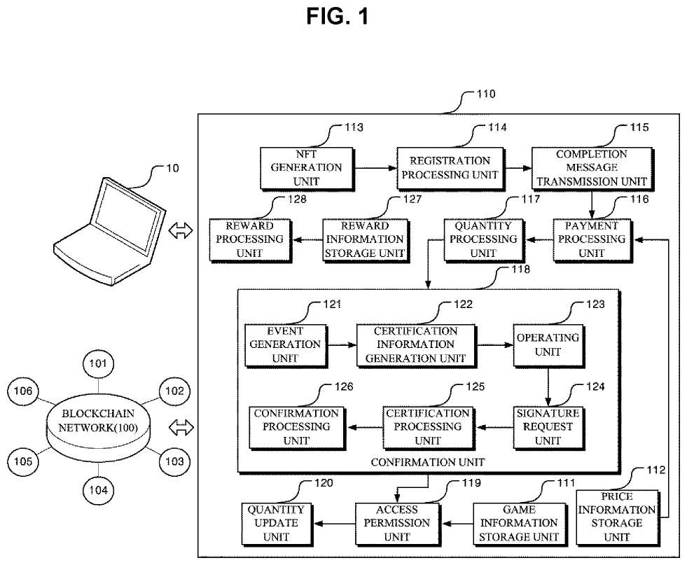

FIG. 1 is a diagram illustrating a structure of a service providing server providing a tournament game service using an NFT according to an exemplary embodiment of the present disclosure.

Referring to FIG. 1, the service providing server 110 according to the present disclosure includes a game information storage unit 111, a price information storage unit 112, an NFT generation unit 113, a registration processing unit 114, a completion message transmission unit 115, a payment processing unit 116, and a quantity processing unit 117.

The game information storage unit 111 stores information on the number of required tickets for participating in tournaments of a plurality of predetermined respective games.

For example, the game information storage unit 111 may store information shown in Table 1 below.

TABLE 1

| | Number of |
|---|---|
| Plurality | required |
| of games | tickets |
| Game 1 | 2 |
| Game 2 | 1 |
| Game 3 | 5 |
| Game 4 | 7 |
| . . . | . . . |

The price information storage unit 112 stores purchase price information of the ticket for participating in the tournament.

For example, the price information storage unit 112 may store purchase price information of ‘5000 won per ticket’ as the purchase price information of the ticket.

When the NFT generation unit 113 receives a new user registration request command for using the tournament game service from a first electronic terminal 10 of a first user, the NFT generation unit 113 requests, to the first electronic terminal 10, transmission of identification information for identifying the first user, and when receiving first user identification information from the first electronic terminal 10, the NFT generation unit 113 generates a first non-fungible token (NFT) including the first user identification information as owner information.

Here, the first user identification information which means unique information for identifying the first user may become information such as a user ID, a resident registration number, a cellular phone number, etc., for using the tournament game service.

In this regard, when the service providing server 110 of the present disclosure receives the first user identification information ‘111111-222222’ from the first electronic terminal 10, the NFT generation unit 113 may generate the first NFT including the first user identification information ‘111111-222222’ as the owner information.

When the first NFT is generated, the registration processing unit 114 registers and processes the first NFT in a predetermined blockchain network 100 for registering the NFT, and completes issuing the first NFT to complete new user registration.

In this case, according to an exemplary embodiment of the present disclosure, the registration processing unit 114 may generate a transaction including the first NFT, and then propagate the transaction to the blockchain network 100 in order to register and process the first NFT in the blockchain network 100. Then, any one node of a plurality of nodes 101, 102, 103, 104, 105, and 106 constituting the blockchain network 100 may generate a block including the transaction and propagate the generated block to the plurality of nodes 101, 102, 103, 104, 105, and 106. As a result, when the block is received in the plurality of nodes 101, 102, 103, 104, 105, and 106, the plurality of nodes 101, 102, 103, 104, 105, and 106 connects the block to blockchain data by a chain based on a previous block connected to blockchain data stored in each node by the chain to share the first NFT.

As such, when issuing the first NFT is completed by the registration processing unit 114, the completion message transmission unit 115 generates a registration completion message indicating that issuing the first NFT is completed and at the same time, indicating that the new user registration is completed, and transmits the registration completion message to the first electronic terminal 10.

In this case, when the first electronic terminal 10 receives the registration completion message from the service providing server 110 of the present disclosure, the first electronic terminal 10 may output the registration completion message on a screen as a text. Through this, the first user may confirm that issuing the first NFT is completed and at the same time, that new subscription of the first user in the tournament game service is completed.

As such, when issuing the first NFT is completed, the first user may perform purchasing a ticket for participating in a tournament of a predetermined game using the first electronic terminal 10. In this regard, the first user may access the service providing server 110 of the present disclosure, and then transmit a command of requesting purchasing tickets of a purchase quantity desired thereby, by using the first electronic terminal 10.

In this regard, upon receiving the purchase request command of requesting purchasing tickets as many as a first purchase quantity from the first electronic terminal 10 to the service providing server 110 of the present disclosure, the payment processing unit 116 requests transmission of payment means information to the first electronic terminal 10, and upon receiving first payment means information from the first electronic terminal 10, the payment processing unit 116 calculates a price corresponding to the first purchase quantity based on the purchase price information stored in the price information storage unit 112, and then perform payment processing for the calculated price based on the first payment means information.

For example, when the purchase price information of the ticket is designated as ‘5000 won per ticket’, and the service providing server 110 receives the purchase request command of requesting purchasing ‘5’ tickets from the first electronic terminal 10, the payment processing unit 116 may request transmission of the payment means information to the first electronic terminal 10, and when the service providing server 110 receives credit card information from the first electronic terminal 10 in response thereto, the payment processing unit 116 may calculate a price corresponding to the purchase quantity of ‘5’ tickets as ‘25000 won’ based on the purchase price information, and then perform payment processing for ‘25000 won’ based on the credit card information.

When the payment processing is completed, the quantity processing unit 117 generates a first transaction indicting that the first user possesses tickets of the first purchase quantity, and registers and processes the first transaction in the blockchain network 100 to process the first purchase quantity to be recorded in the first NFT registered in the blockchain network 100 as information on a ticket holding quantity of the first user.

In this regard, as in the above-described example, when the payment processing unit 116 completes payment processing for a price for a ticket purchase quantity of ‘5’, the quantity processing unit 117 generates the first transaction indicating that the first user possesses ‘5’ tickets, and registers and processes the first transaction in the blockchain network 100 to process a quantity called ‘5’; as the information on the ticket holding quantity of the first user to be recorded in the first NFT registered in the blockchain network 100.

In this case, according to an exemplary embodiment of the present disclosure, the payment processing unit 116 may propagate the first transaction to the blockchain network 100 in order to register and process the first transaction in the blockchain network 100. Then, any one node of a plurality of nodes 101, 102, 103, 104, 105, and 106 constituting the blockchain network 100 may generate a block including the first transaction and propagate the generated block to the plurality of nodes 101, 102, 103, 104, 105, and 106. As a result, when the block is received in the plurality of nodes 101, 102, 103, 104, 105, and 106, the plurality of nodes 101, 102, 103, 104, 105, and 106 may record a quantity called ‘5’ as the information on the ticket holding quantity of the first user in the first NFT included in the blockchain data stored in each node based on the first transaction on the received block.

In such a situation, an operator of the service providing server 110 according to the present disclosure may hold a tournament competition for each of the plurality of games in order to provide the tournament game service, and in this case, the operator may open a tournament session of each of the plurality of games online in order to allow the members to participate in the tournament competition for each of the plurality of games online through electronic terminals held by the members.

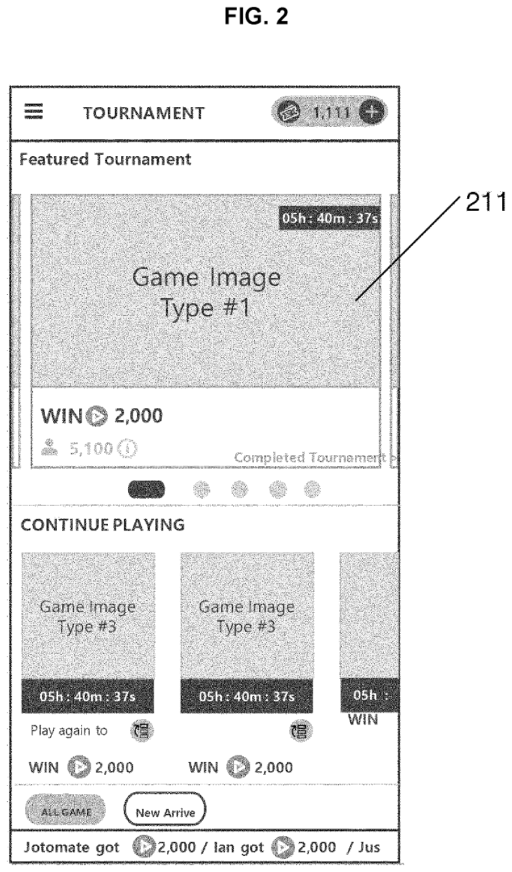

In this regard, FIG. 2 is a diagram illustrating an example of a screen in which when a specific member accesses the service providing server 110 through an electronic terminal thereof, a tournament session of each of the plurality of games is opened, which may be viewed through the electronic terminal. Here, when reference numeral 211 of FIG. 2 represents a screen in which a tournament session for a first game which is any one of the plurality of games is opened, the tournament session means a session opened so as for members who accesses the tournament session to play the first game online together through the electronic terminal. That is, multiple members access the tournament session through electronic terminals thereof to play the first game jointly with each other online.

As a result, the first user who completes the new user registration in the tournament game service accesses the service providing server 110 through the first electronic terminal 10 thereof to view a waiting room screen having a UI illustrated in FIG. 2.

In this case, when the first user clicks on the tournament session for the first game represented by reference numeral 211 through the first electronic terminal 10, the first electronic terminal 10 may transmit, to the service providing server 110 of the present disclosure, an access request command to the tournament session.

In this case, according to an exemplary embodiment of the present disclosure, the service providing server 110 as a component for processing an access request command to the tournament session received from the first electronic terminal 10 may further include a confirmation unit 118 and an access permission unit 119.

When the confirmation unit 118 receives an access request command to a tournament session (the tournament session means a session opened for users accessing the tournament session through the electronic terminal to play the first game jointly online) opened for a first game which is any one of the plurality of games, from the first electronic terminal 10 after the registration processing of the first transaction in the blockchain network 100 is completed, the confirmation unit 118 requests transmission of identification information for identifying the first user, to the first electronic terminal 10, and when receiving the first user identification information from the first electronic terminal, the confirmation unit 118 inquires the first NFT registered in the blockchain network 100 based on the first user identification information, and confirms the first purchase quantity as the information on the ticket holding quantity of the first user recorded in the first NFT.

In this regard, as in the above-described example, when it is assumed that the first user identification information ‘111111-222222’ is recorded as the owner information in the first NFT, and the quantity of ‘5’ is recorded as the information on the ticket holding quantity of the first user, the confirmation unit 118 inquires the first NFT registered in the blockchain network 100 based on the first user identification information ‘111111-222222’ to confirm ‘5’ which is the information on the ticket holding quantity of the first user included in the first NFT.

The access permission unit 119 confirms a first required number which is a required number of tickets for participating in the tournament of the first game by referring to the game information storage unit 111, and when it is confirmed that the first purchase quantity is equal to or more than the first required number, the access permission unit 119 permits the access to the tournament session to process the first electronic terminal 10 to access the tournament session.

In this regard, when it is assumed that information is stored in the game information storage unit 111 as in Table 1 above, the first game is referred to as ‘game 2’, and the holding quantity of tickets held by the first user is confirmed as ‘5’, the holding quantity of tickets held by the first user is equal to or more than ‘1’ which is the first required number for participating in the tournament for ‘game 2’, so the access permission unit 119 permits the first electronic terminal 10 to access the tournament session for ‘game 2’ to process the first electronic terminal 10 to access the tournament session.

Through this, the first user accesses the tournament session for the first game by using the first electronic terminal 10 to play the first game jointly with other users who access the tournament session in the form of the tournament online.

In this case, according to an exemplary embodiment of the present disclosure, the service providing server 110 may further include a quantity update unit 120.

When the access of the first electronic terminal 10 to the tournament session is permitted, the quantity update unit 120 generates a second transaction indicting that the first user expends the tickets of the first required number, and registers and processes the second transaction in the blockchain network 100 to process the first purchase quantity which is the information on the ticket holding quantity of the first user in the first NFT registered in the blockchain network 100 to be reduced by the first required number, and recorded.

In this regard, as in the above-described example, as the first electronic terminal 10 accesses the tournament session for ‘game 2’, when the first required number is ‘1’, the quantity update unit 120 generates a second transaction indicating that the first user expends a ticket of ‘1’ which is the first required number, and registers and processes the second transaction in the blockchain network 100 to process ‘5’ which is the information on the ticket holding quantity of the first user in the first NFT registered in the blockchain network 100 to be reduced by ‘1’ which is the first required number and changed to ‘4’, and recorded.

In this case, according to an exemplary embodiment of the present disclosure, the quantity update unit 120 may propagate the second transaction to the blockchain network 100 in order to register and process the second transaction in the blockchain network 100. Then, any one node of a plurality of nodes 101, 102, 103, 104, 105, and 106 constituting the blockchain network 100 may generate a block including the second transaction and propagate the generated block to the plurality of nodes 101, 102, 103, 104, 105, and 106. As a result, when the block is received in the plurality of nodes 101, 102, 103, 104, 105, and 106, the plurality of nodes 101, 102, 103, 104, 105, and 106 may change ‘5’ which is the information on the ticket holding quantity of the first user in the first NFT included in the blockchain data stored in each node, to ‘4’, and record ‘4’, based on the second transaction on the received block.

In this case, according to an exemplary embodiment of the present disclosure, upon receiving the access request command to the tournament session opened for the first game from the first electronic terminal 10, the service providing server 110 performs the certification for the first user, and then only when it is confirmed that the first user is a certified member, the service providing server 110 may further include a configuration of conducting a process for determining whether to allow the first electronic terminal 10 to access the tournament session based on the ticket held by the first user.

In this regard, the completion message transmission unit 115 may include a component which stores in predetermined certification information for certifying the first user in a member database (not illustrated) afterward in the process of completing the new user registration for the first user.

In this regard, as issuing the first NFT for the first user is completed, when the registration completion message is transmitted to the first electronic terminal 10, the completion message transmission unit 115 may request transmission of a public key for electronic signature verification and e-mail address information held by the first user, to the first electronic terminal 10.

In this case, it is assumed that a predetermined first private key for an electronic signature and a first public key corresponding thereto are pre-stored in the first electronic terminal 10. As a result, when the first electronic terminal 10 receives a transmission request of the public key and the e-mail address information from the service providing server 110 of the present disclosure, the first electronic terminal 10 may receive, from the first user, information on a first e-mail address according to an account of the first user, and then, transmit, to the service providing server 110 of the present disclosure, the first public key stored in the first electronic terminal 10, and the information on the first e-mail address received from the first user.

As such, when the service providing server 110 of the present disclosure receives the first public key corresponding to the first private key pre-stored in the first electronic terminal 10, and the information on the first e-mail address from the first electronic terminal 10, the completion message transmission unit 115 may store, in the member database, the first user identification information, and the first public key and the information on the first e-mail address to correspond to each other.

In this case, according to an exemplary embodiment of the present disclosure, the confirmation unit 118 as a component for conducting user certification may include an event generation unit 121, a certification information generation unit 122, an operating unit 123, a signature request unit 124, a certification processing unit 125, and a confirmation processing unit 126.

The event generation unit 121 generates a certification event for conducting e-mail based user certification for the first user when receiving the access request command to the tournament session opened for the first game from the first electronic terminal 10.

The certification information generation unit 122 randomly generates, when the certification event is generated, an n (n is a natural number of 2 or more)-digit first certification number, randomly generates a certification value constituted by a natural number having a size of 9 or less, and then, performs a modulo operation having the certification value as a divisor for respective digit numbers constituting the first certification number to generate an n-digit second certification number.

For example, when it is assumed that n is ‘3’, the certification information generation unit 122 randomly generates a 3-digit first certification number as ‘642’, randomly generates the certification value as ‘5’, and then performs a modulo operation having ‘5’ which is the certification value as the divisor for ‘6’, ‘4’, and ‘2’ which are respective digit numbers constituting the first certification number to generate a 3-digit second certification number as ‘142’.

The operating unit 123 generates a column vector having respective digit numbers constituting the first certification number as components and a row vector having respective digit numbers constituting the second certification number as components, and operates a matrix multiplication between the column vector and the row vector to generate an operation matrix of an n×n size, and then operates Frobenius Norm of the operation matrix.

Here, Frobenius Norm means L2-Norm that represents the size of the matrix.

In this regard, as in the above-described example, when the first certification number is generated as ‘642’ and the second certification number is generated as ‘142’ through the certification information generation unit 122, the operating unit 123 generates a column vector having respective digit numbers constituting ‘642’ which is the first certification number as components as

$$‘ [ \begin{matrix}6 \\ 4 \\ 2\end{matrix} ] ’ ,$$

generates a row vector having respective digit numbers constituting ‘142’ which is the second certification number as components as ‘[1 4 2]’, and then operates the matrix multiplication between the column vector and the row vector to generate an operation matrix having a size of 3×3 as

$$‘ [ \begin{matrix}6 & 24 & 12 \\ 4 & 16 & 8 \\ 2 & 8 & 4\end{matrix} ] ’ ,$$

and operate Frobenius Norm of the operation matrix.

The signature request unit 124 requests transmission of identification information for identifying the first user to the first electronic terminal 10, and when receiving the first user identification information from the first electronic terminal 10, confirms the first e-mail address stored to correspond to the first user identification information from the member database, sends a certification e-mail including the first certification number with the first e-mail address as a receiver, and then transmits the certification value to the first electronic terminal 10, and at the same time, requests the electronic signature based on the first certification number and the certification value.

For example, as in the above-described example, when the first certification number and the certification value are set to ‘642’ and ‘5’, respectively, the signature request unit 124 may request the transmission of the identification information for identifying the first user to the first electronic terminal 10, and when receiving the first user identification information from the first electronic terminal 10, confirms the first e-mail address stored to correspond to the first user identification information from the member database, and then send a certification e-mail including ‘642’ which is the first certification number with the first e-mail address as the receiver. Then, the signature request unit 124 may transmit ‘5’ which is the certification value to the first electronic terminal 10, and at the same time, request the electronic signature based on the first certification number and the certification value.

In this case, according to an exemplary embodiment of the present disclosure, upon receiving the electronic signature request from the service providing server 110 jointly with the certification value, the first electronic terminal 10 may display a message for requesting the first user to input the first certification number included in the certification e-mail received by an account according to the first e-mail address into the first electronic terminal 10.

In this case, when the first user inputs, into the first electronic terminal 10, the first certification number included in the certification e-mail received by the account according to the first e-mail address in response to the message, the first electronic terminal 10 performs the modulo operation having the certification value as the divisor for the respective digit numbers constituting the first certification number to generate the n-digit second certification number, and then generate a column vector having respective digit numbers constituting the first certification number as components and a row vector having respective digit numbers constituting the second certification number as components, and operates the matrix multiplication between the column vector and the row vector to generate the operation matrix of the n×n size, and then sign the Frobenius Norm of the operation matrix with the first private key for the first user stored in the first electronic terminal 10 to generate a first electronic signature value, and transmit the generated first electronic signature value to the service providing server 110 of the present disclosure.

In this regard, as in the above-described example, when the first certification number and the certification value are ‘642’ and ‘5’, respectively, the first electronic terminal 10 may display a message for requesting the first user to input the first certification number included in the certification e-mail received by the account according to the first e-mail address into the first electronic terminal 10 when receiving the electronic signature request from the service providing server 110 jointly with ‘5’ which is the certification value.

Then, the first user logs into the account according to the first e-mail address to confirm the certification e-mail, and confirms ‘642’ which is the first certification number included in the certification e-mail to input ‘642’ which is the first certification number into the first electronic terminal 10.

As such, when the first user inputs ‘642’ which is the first certification number included in the certification e-mail into the first electronic terminal 10, the first electronic terminal 10 performs a modulo operation having ‘5’ which is the certification value as the divisor for “6’, ‘4’, and ‘2’ which are respective digit numbers constituting the first certification number to generate a 3-digit second certification number as ‘142’.

Then, the first electronic terminal 10 generates a column vector having respective digit numbers constituting ‘642’ which is the first certification number as components as

$$‘ [ \begin{matrix}6 \\ 4 \\ 2\end{matrix} ] ’$$

and generates a row vector having respective digit numbers constituting ‘142’ which is the second certification number as components as ‘[1 4 2]’, and then operates the matrix multiplication between the column vector and the row vector to generate an operation matrix of a 3×3 size as

$$‘ [ \begin{matrix}6 & 24 & 12 \\ 4 & 16 & 8 \\ 2 & 8 & 4\end{matrix} ] ’ .$$

Thereafter, the first electronic terminal 10 operates the Frobenius Norm of the operation matrix, and then performs the electronic signature for the Frobenius Norm based on the first private key pre-stored in the first electronic terminal 10 to generate the first electronic signature value and transmit the first electronic signature value to the service providing server 110 of the present disclosure.

Upon receiving the first electronic signature value in response to the electronic signature request from the first electronic terminal 10, the certification processing unit 125 extracts the first public key stored to correspond to the first user identification information from the member database, and then compares a value acquired by decoding the first electronic signature value based on the first public key and the Frobenius Norm of the operation matrix with each other, and when it is confirmed that both values coincide with each other, completes the certification for the first user.

When the certification for the first user is completed, the confirmation processing unit 126 inquires the first NFT registered in the blockchain network 100 based on the first user identification information to confirm the first purchase quantity as the information on the ticket holding quantity of the first user recorded in the first NFT.

According to an exemplary embodiment of the present disclosure, the service providing server 110 may further include a configuration for paying a predetermined reward when a user who participates in a tournament for a predetermined game wins the tournament.

In this regard, the service providing server 110 according to the present disclosure may further include a reward information storage unit 127 and a reward processing unit 128.

The reward information storage unit 127 stores information on the amount of payment of cryptocurrency to be paid as a reward when winning the tournament for each of the plurality of games.

For example, the reward information storage unit 127 may store information shown in Table 2 below.

TABLE 2

| | Payment |
|---|---|
| Plurality | amount of |
| of games | cryptocurrency |
| Game 1 | 5 coins |
| Game 2 | 2 coins |
| Game 3 | 13 coins |
| Game 4 | 20 coins |
| . . . | . . . |

When an event occurs, which indicates that the first user is a winner through the tournament session as the first user wins the tournament for the first game after the first user completes participating in the tournament for the first game as the first electronic terminal 10 accesses the tournament session, the reward processing unit 128 confirms a first payment amount which is the payment amount of the cryptocurrency to be paid as the reward when winning the tournament for the first game by referring to the reward information storage unit 127, and receives information on a wallet address of the first user for accumulating the cryptocurrency from the first electronic terminal 10, and then transfers the cryptocurrency of the first payment amount to the wallet address of the first user to complete the reward processing for the first user.

In this regard, as in the above-described example, a situation is assumed in which the first game is ‘game 2’, and as the first electronic terminal 10 accesses the tournament session opened for ‘game 2’, the first user completes participating in the tournament for the ‘game 2’.

When the first user wins the tournament for ‘game 2’, the service providing server 110 of the present disclosure may generate an event indicating that the first user is the winner through the tournament session opened for ‘game 2’. As such, when the event indicating that the first user is the winner is generated through the tournament session for ‘game 2’, the reward processing unit 128 may confirm that the payment amount of the cryptocurrency to be paid as the reward when winning the tournament for ‘game 2’ is ‘2 coins’ by referring to the reward information storage unit 127.

Then, the reward processing unit 128 requests the first electronic terminal 10 to transmit the information on the wallet address of the first user for accumulating the cryptocurrency, and then when receiving the information on the wallet address of the first user from the first electronic terminal 10, transfers the cryptocurrency of ‘2 coins’ to the wallet address of the first user to complete the reward processing for the first user.

Through this, when the members who subscribes to and registers in the tournament game service of the present disclosure win the tournaments for the games participated thereby, the members may receive the rewards thereof as the cryptocurrency, and will be able to more actively participate in the tournaments for the games due to the reward.

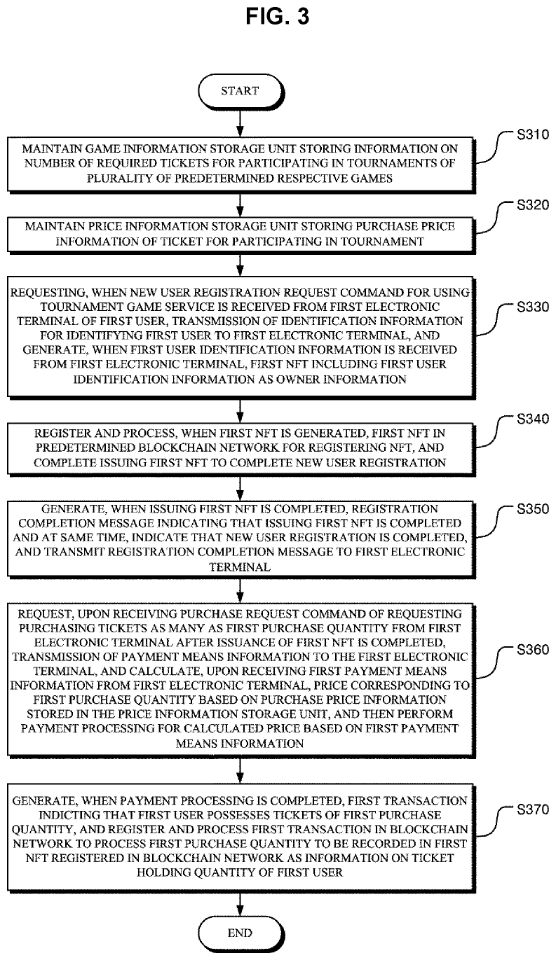

FIG. 3 is a flowchart illustrating an operating method of a service providing server providing a tournament game service using an NFT according to an exemplary embodiment of the present disclosure.

In step S310, a game information storage unit is maintained, which stores information on the number of required tickets for participating in tournaments of a plurality of predetermined respective games.

In step S320, a price information storage unit is maintained, which stores purchase price information of the ticket for participating in the tournament.

In step S330, when a new user registration request command for using the tournament game service is received from a first electronic terminal of a first user, transmission of identification information for identifying the first user is requested to the first electronic terminal, and when first user identification information is received from the first electronic terminal, a first NFT including the first user identification information as owner information is generated.

In step S340, when the first NFT is generated, the first NFT is registered and processed in a predetermined blockchain network for registering the NFT, and issuing the first NFT is completed to complete new user registration.

In step S350, when issuing the first NFT is completed, a registration completion message indicating that issuing the first NFT is completed and at the same time, indicating that the new user registration is completed is generated, and transmitted to the first electronic terminal.

In step S360, upon receiving the purchase request command of requesting purchasing tickets as many as a first purchase quantity from the first electronic terminal after the issuance of the first NFT is completed, transmission of payment means information is requested to the first electronic terminal, and upon receiving first payment means information from the first electronic terminal, a price corresponding to the first purchase quantity is calculated based on the purchase price information stored in the price information storage unit, and then payment processing for the calculated price is performed based on the first payment means information.

In step S370, when the payment processing is completed, a first transaction indicting that the first user possesses tickets of the first purchase quantity is generated, and the first transaction is registered and processed in the blockchain network to process the first purchase quantity to be recorded in the first NFT registered in the blockchain network as information on a ticket holding quantity of the first user.

In this case, according to an exemplary embodiment of the present disclosure, the operating method of the service providing server may further include requesting, when receiving an access request command to a tournament session (the tournament session means a session opened for users accessing the tournament session through the electronic terminal to play the first game jointly online) opened for a first game which is any one of the plurality of games from the first electronic terminal after the registration processing of the first transaction in the blockchain network is completed, transmission of identification information for identifying the first user, to the first electronic terminal, and when receiving the first user identification information from the first electronic terminal, inquiring the first NFT registered in the blockchain network based on the first user identification information, and confirming the first purchase quantity as the information on the ticket holding quantity of the first user recorded in the first NFT, and confirming a first required number which is a required number of tickets for participating in the tournament of the first game by referring to the game information storage unit, and when it is confirmed that the first purchase quantity is equal to or more than the first required number, permitting the access to the tournament session to process the first electronic terminal to access the tournament session.

In this case, according to an exemplary embodiment of the present disclosure, the operating method of the service providing server may further include, when the access of the first electronic terminal to the tournament session is permitted, generating a second transaction indicting that the first user expends the tickets of the first required number, and registers and processing the second transaction in the blockchain network to process the first purchase quantity which is the information on the ticket holding quantity of the first user in the first NFT registered in the blockchain network to be reduced by the first required number, and recorded.

According to an exemplary embodiment of the present disclosure, in step S350, when the registration completion message is transmitted to the first electronic terminal, transmission of a public key for electronic signature verification and e-mail address information held by the first user may be requested to the first electronic terminal, and when the first public key corresponding to the first private key pre-stored in the first electronic terminal, and the information on the first e-mail address are received from the first electronic terminal, the first user identification information, and the first public key and the information on the first e-mail address may be stored in the member database to correspond to each other.

In this case, the confirming may include generating a certification event for conducting e-mail based user certification for the first user when receiving the access request command to the tournament session opened for the first game from the first electronic terminal, randomly generating, when the certification event is generated, a n (n is a natural number of 2 or more)-digit first certification number, randomly generates a certification value constituted by a natural number having a size of 9 or less, and then, performing a modulo operation having the certification value as a divisor for respective digit numbers constituting the first certification number to generate an n-digit second certification number, generating a column vector having respective digit numbers constituting the first certification number as components and a row vector having respective digit numbers constituting the second certification number as components, and operating a matrix multiplication between the column vector and the row vector to generate an operation matrix of an n×n size, and then operating Frobenius Norm of the operation matrix, requesting transmission of identification information for identifying the first user to the first electronic terminal, and when receiving the first user identification information from the first electronic terminal, confirming the first e-mail address stored to correspond to the first user identification information from the member database, sending a certification e-mail including the first certification number with the first e-mail address as a receiver, and then transmitting the certification value to the first electronic terminal, and at the same time, requesting the electronic signature based on the first certification number and the certification value, when receiving a first electronic signature value (the first electronic signature value is generated by performing, when the certification value is received in the first electronic terminal, and the first user inputs the first certification number included in the certification e-mail received by an account according to the first e-mail address into the first electronic terminal, by the first electronic terminal, the modulo operation having the certification value as the divisor for the respective digit numbers constituting the first certification number to generate the n-digit second certification number, and then generate a column vector having respective digit numbers constituting the first certification number as components and a row vector having respective digit numbers constituting the second certification number as components, and operating the matrix multiplication between the column vector and the row vector to generate the operation matrix of the n×n size, and then signing the Frobenius Norm of the operation matrix with the first private key stored in the first electronic terminal) from the first electronic terminal in response to the electronic signature request, extracting the first public key stored to correspond to the first user identification information from the member database, and then comparing a value acquired by decoding the first electronic signature value based on the first public key and the Frobenius Norm of the operation matrix with each other, and when it is confirmed that both values coincide with each other, completing the certification for the first user, and when the certification for the first user is completed, inquiring the first NFT registered in the blockchain network based on the first user identification information to confirm the first purchase quantity as the information on the ticket holding quantity of the first user recorded in the first NFT.

According to an exemplary embodiment of the present disclosure, the operating method of the service providing server may further include a step of maintaining a reward information storage unit storing information on the amount of payment of cryptocurrency to be paid as a reward when winning the tournament for each of the plurality of games, a step of confirming, when an event occurs, which indicates that the first user is a winner through the tournament session as the first user wins the tournament for the first game after the first user completes participating in the tournament for the first game as the first electronic terminal accesses the tournament session, a first payment amount which is the payment amount of the cryptocurrency to be paid as the reward when winning the tournament for the first game by referring to the reward information storage unit, and a step of receiving information on a wallet address of the first user for accumulating the cryptocurrency from the first electronic terminal, and then transferring the cryptocurrency of the first payment amount to the wallet address of the first user to complete reward processing for the first user.

Hereinabove, referring to FIG. 3, the operating method of the service providing server according to an exemplary embodiment of the present disclosure is described. Here, since the operating method of the service providing server according to an exemplary embodiment of the present disclosure may correspond to the configuration of the operation of the service providing server 110 described by using FIGS. 1 and 2, a more detailed description thereof will be omitted.

The operating method of the service providing server according to an exemplary embodiment of the present disclosure may be implemented by a computer program stored in a storage medium for executing the computer program through combination with a computer.

The operating method of the service providing server according to an exemplary embodiment of the present disclosure may be implemented in a program command type which may be performed through various computer means and recorded in a computer readable medium. The computer readable medium may include a program command, a data file, a data structure, etc., singly or combinationally. The program command recorded in the medium may be specially designed and configured for the present disclosure, or may be publicly known to and used by those skilled in the computer software field. An example of the computer readable recording medium includes magnetic media, such as a hard disk, a floppy disk, and a magnetic tape, optical media such as a CD-ROM and a DVD, magneto-optical media such as a floptical disk, and hardware devices such as a ROM, a RAM, and a flash memory, which are specially configured to store and execute the program command. An example of the program command includes a high-level language code executable by a computer by using an interpreter and the like, as well as a machine language code created by a compiler.

As described above, the present disclosure has been described by specified matters such as detailed components, and the like and limited exemplary embodiments and drawings, but the description is just provided to assist more overall understanding of the present disclosure and the present disclosure is not limited to the exemplary embodiment and various modifications and changes can be made by those skilled in the art from such a disclosure.

Accordingly, the spirit of the present disclosure should not be defined only by the described exemplary embodiments, and it should be appreciated that claims to be described below and all things which are equivalent to the claims or equivalently modified to the claims are included in the scope of the spirit of the present disclosure.

What is claimed is:

1. A service providing server providing a tournament game service using a non-fungible token (NFT), comprising:
a game information storage unit storing information on the number of required tickets for participating in tournaments of a plurality of predetermined respective games;
a price information storage unit storing purchase price information of the ticket for participating in the tournament;
an NFT generation unit requesting, when a new user registration request command for using the tournament game service is received from a first electronic terminal of a first user, transmission of identification information for identifying the first user to the first electronic terminal, and generating, when first user identification information is received from the first electronic terminal, a first NFT including the first user identification information as owner information;
a registration processing unit registering and processing, when the first NFT is generated, the first NFT in a predetermined blockchain network for registering the NFT, and completing issuing the first NFT to complete new user registration;
a completion message transmission unit generating, when issuing the first NFT is completed, a registration completion message indicating that issuing the first NFT is completed and at the same time, indicating that the new user registration is completed, and transmitting the registration completion message to the first electronic terminal;
a payment processing unit requesting, upon receiving the purchase request command of requesting purchasing tickets as many as a first purchase quantity from the first electronic terminal after the issuance of the first NFT is completed, transmission of payment means information to the first electronic terminal, and calculating, upon receiving first payment means information from the first electronic terminal, a price corresponding to the first purchase quantity based on the purchase price information stored in the price information storage unit, and then performing payment processing for the calculated price based on the first payment means information; and
a quantity processing unit generating, when the payment processing is completed, a first transaction indicting that the first user possesses tickets of the first purchase quantity, and registering and processing the first transaction in the blockchain network to process the first purchase quantity to be recorded in the first NFT registered in the blockchain network as information on a ticket holding quantity of the first user.

2. The service providing server of claim 1, further comprising:
a confirmation unit requesting, when receiving an access request command to a tournament session, wherein the tournament session means a session opened for users accessing the tournament session through the electronic terminal to play the first game jointly online, opened for a first game which is any one of the plurality of games, from the first electronic terminal after the registration processing of the first transaction in the blockchain network is completed, transmission of identification information for identifying the first user, to the first electronic terminal, and when receiving the first user identification information from the first electronic terminal, inquiring the first NFT registered in the blockchain network based on the first user identification information, and confirming the first purchase quantity as the information on the ticket holding quantity of the first user recorded in the first NFT; and
an access permission unit confirming a first required number which is a required number of tickets for participating in the tournament of the first game by referring to the game information storage unit, and when it is confirmed that the first purchase quantity is equal to or more than the first required number, permitting the access to the tournament session to process the first electronic terminal to access the tournament session.

3. The service providing server of claim 2, further comprising:
a quantity update unit generating, when the access of the first electronic terminal to the tournament session is permitted, a second transaction indicting that the first user expends the tickets of the first required number, and registering and processing the second transaction in the blockchain network to process the first purchase quantity which is the information on the ticket holding quantity of the first user in the first NFT registered in the blockchain network to be reduced by the first required number, and recorded.

4. The service providing server of claim 2, wherein when the registration completion message is transmitted to the first electronic terminal, the completion message transmission unit requests transmission of a public key for electronic signature verification and e-mail address information held by the first user to the first electronic terminal, and when the first public key corresponding to the first private key pre-stored in the first electronic terminal, and the information on the first e-mail address are received from the first electronic terminal, stores the first user identification information, and the first public key and the information on the first e-mail address in the member database to correspond to each other, and
the confirmation unit includes
an event generation unit generating a certification event for conducting e-mail based user certification for the first user when receiving the access request command to the tournament session opened for the first game from the first electronic terminal,
a certification information generation unit randomly generating, when the certification event is generated, a n, wherein n is a natural number of 2 or more, digit first certification number, randomly generating a certification value constituted by a natural number having a size of 9 or less, and then, performing a modulo operation having the certification value as a divisor for respective digit numbers constituting the first certification number to generate an n-digit second certification number,
an operating unit generating a column vector having respective digit numbers constituting the first certification number as components and a row vector having respective digit numbers constituting the second certification number as components, and operating a matrix multiplication between the column vector and the row vector to generate an operation matrix of an n×n size, and then operating Frobenius Norm of the operation matrix,
a signature request unit requesting transmission of identification information for identifying the first user to the first electronic terminal, and when receiving the first user identification information from the first electronic terminal, confirming the first e-mail address stored to correspond to the first user identification information from the member database, sending a certification e-mail including the first certification number with the first e-mail address as a receiver, and then transmitting the certification value to the first electronic terminal, and at the same time, requesting the electronic signature based on the first certification number and the certification value,
a certification processing unit extracting, when receiving a first electronic signature value, wherein the first electronic signature value is generated by performing, when the certification value is received in the first electronic terminal, and the first user inputs the first certification number included in the certification e-mail received by an account according to the first e-mail address into the first electronic terminal, by the first electronic terminal, the modulo operation having the certification value as the divisor for the respective digit numbers constituting the first certification number to generate the n-digit second certification number, and then generate a column vector having respective digit numbers constituting the first certification number as components and a row vector having respective digit numbers constituting the second certification number as components, and operating the matrix multiplication between the column vector and the row vector to generate the operation matrix of the n×n size, and then signing the Frobenius Norm of the operation matrix with the first private key stored in the first electronic terminal, from the first electronic terminal in response to the electronic signature request, the first public key stored to correspond to the first user identification information from the member database, and then comparing a value acquired by decoding the first electronic signature value based on the first public key and the Frobenius Norm of the operation matrix with each other, and when it is confirmed that both values coincide with each other, completing the certification for the first user, and
a confirmation processing unit inquiring, when the certification for the first user is completed, the first NFT registered in the blockchain network based on the first user identification information to confirm the first purchase quantity as the information on the ticket holding quantity of the first user recorded in the first NFT.

5. The service providing server of claim 1, further comprising:
a reward information storage unit storing information on the amount of payment of cryptocurrency to be paid as a reward when winning the tournament for each of the plurality of games; and
a reward processing unit confirming, when an event occurs, which indicates that the first user is a winner through the tournament session as the first user wins the tournament for the first game after the first user completes participating in the tournament for the first game as the first electronic terminal accesses the tournament session, a first payment amount which is the payment amount of the cryptocurrency to be paid as the reward when winning the tournament for the first game by referring to the reward information storage unit, and receiving information on a wallet address of the first user for accumulating the cryptocurrency from the first electronic terminal, and then transferring the cryptocurrency of the first payment amount to the wallet address of the first user to complete the reward processing for the first user.

6. An operating method of a service providing server providing a tournament game service using a non-fungible token (NFT), comprising:
maintaining a game information storage unit storing information on the number of required tickets for participating in tournaments of a plurality of predetermined respective games;
maintaining a price information storage unit storing purchase price information of the ticket for participating in the tournament;
requesting, when a new user registration request command for using the tournament game service is received from a first electronic terminal of a first user, transmission of identification information for identifying the first user to the first electronic terminal, and generating, when first user identification information is received from the first electronic terminal, a first NFT including the first user identification information as owner information;
registering and processing, when the first NFT is generated, the first NFT in a predetermined blockchain network for registering the NFT, and completing issuing the first NFT to complete new user registration;
generating, when issuing the first NFT is completed, a registration completion message indicating that issuing the first NFT is completed and at the same time, indicating that the new user registration is completed, and transmitting the registration completion message to the first electronic terminal;
requesting, upon receiving the purchase request command of requesting purchasing tickets as many as a first purchase quantity from the first electronic terminal after the issuance of the first NFT is completed, transmission of payment means information to the first electronic terminal, and calculating, upon receiving first payment means information from the first electronic terminal, a price corresponding to the first purchase quantity based on the purchase price information stored in the price information storage unit, and then performing payment processing for the calculated price based on the first payment means information; and
generating, when the payment processing is completed, a first transaction indicting that the first user possesses tickets of the first purchase quantity, and registering and processing the first transaction in the blockchain network to process the first purchase quantity to be recorded in the first NFT registered in the blockchain network as information on a ticket holding quantity of the first user.

7. The operating method of claim 6, further comprising:
requesting, when receiving an access request command to a tournament session, wherein the tournament session means a session opened for users accessing the tournament session through the electronic terminal to play the first game jointly online, opened for a first game which is any one of the plurality of games, from the first electronic terminal after the registration processing of the first transaction in the blockchain network is completed, transmission of identification information for identifying the first user, to the first electronic terminal, and when receiving the first user identification information from the first electronic terminal, inquiring the first NFT registered in the blockchain network based on the first user identification information, and confirming the first purchase quantity as the information on the ticket holding quantity of the first user recorded in the first NFT; and
confirming a first required number which is a required number of tickets for participating in the tournament of the first game by referring to the game information storage unit, and when it is confirmed that the first purchase quantity is equal to or more than the first required number, permitting the access to the tournament session to process the first electronic terminal to access the tournament session.

8. The operating method of claim 7, further comprising:
generating, when the access of the first electronic terminal to the tournament session is permitted, a second transaction indicting that the first user expends the tickets of the first required number, and registering and processing the second transaction in the blockchain network to process the first purchase quantity which is the information on the ticket holding quantity of the first user in the first NFT registered in the blockchain network to be reduced by the first required number, and recorded.

9. The operating method of claim 7, wherein in the transmitting of the registration completion message to the first electronic terminal,
when the registration completion message is transmitted to the first electronic terminal, transmission of a public key for electronic signature verification and e-mail address information held by the first user is requested to the first electronic terminal, and when the first public key corresponding to the first private key pre-stored in the first electronic terminal, and the information on the first e-mail address are received from the first electronic terminal, the first user identification information, and the first public key and the information on the first e-mail address are stored in the member database to correspond to each other, and
the confirming includes
generating a certification event for conducting e-mail based user certification for the first user when receiving the access request command to the tournament session opened for the first game from the first electronic terminal,
randomly generating, when the certification event is generated, a n, wherein n is a natural number of 2 or more, digit first certification number, randomly generating a certification value constituted by a natural number having a size of 9 or less, and then, performing a modulo operation having the certification value as a divisor for respective digit numbers constituting the first certification number to generate an n-digit second certification number,
generating a column vector having respective digit numbers constituting the first certification number as components and a row vector having respective digit numbers constituting the second certification number as components, and operating a matrix multiplication between the column vector and the row vector to generate an operation matrix of an n×n size, and then operating Frobenius Norm of the operation matrix,
requesting transmission of identification information for identifying the first user to the first electronic terminal, and when receiving the first user identification information from the first electronic terminal, confirming the first e-mail address stored to correspond to the first user identification information from the member database, sending a certification e-mail including the first certification number with the first e-mail address as a receiver, and then transmitting the certification value to the first electronic terminal, and at the same time, requesting the electronic signature based on the first certification number and the certification value,
extracting, when receiving a first electronic signature value, wherein the first electronic signature value is generated by performing, when the certification value is received in the first electronic terminal, and the first user inputs the first certification number included in the certification e-mail received by an account according to the first e-mail address into the first electronic terminal, by the first electronic terminal, the modulo operation having the certification value as the divisor for the respective digit numbers constituting the first certification number to generate the n-digit second certification number, and then generate a column vector having respective digit numbers constituting the first certification number as components and a row vector having respective digit numbers constituting the second certification number as components, and operating the matrix multiplication between the column vector and the row vector to generate the operation matrix of the n×n size, and then signing the Frobenius Norm of the operation matrix with the first private key stored in the first electronic terminal, from the first electronic terminal in response to the electronic signature request, the first public key stored to correspond to the first user identification information from the member database, and then comparing a value acquired by decoding the first electronic signature value based on the first public key and the Frobenius Norm of the operation matrix with each other, and when it is confirmed that both values coincide with each other, completing the certification for the first user, and
inquiring, when the certification for the first user is completed, the first NFT registered in the blockchain network based on the first user identification information to confirm the first purchase quantity as the information on the ticket holding quantity of the first user recorded in the first NFT.

10. The operating method of claim 6, further comprising:
maintaining a reward information storage unit storing information on the amount of payment of cryptocurrency to be paid as a reward when winning the tournament for each of the plurality of games; and
confirming, when an event occurs, which indicates that the first user is a winner through the tournament session as the first user wins the tournament for the first game after the first user completes participating in the tournament for the first game as the first electronic terminal accesses the tournament session, a first payment amount which is the payment amount of the cryptocurrency to be paid as the reward when winning the tournament for the first game by referring to the reward information storage unit, and receiving information on a wallet address of the first user for accumulating the cryptocurrency from the first electronic terminal, and then transferring the cryptocurrency of the first payment amount to the wallet address of the first user to complete the reward processing for the first user.

11. A non-transitory computer readable recording medium having a program recorded therein for allowing a computer to execute an operating method of a service providing server providing a tournament game service using a non-fungible token (NFT), comprising:
maintaining a game information storage unit storing information on the number of required tickets for participating in tournaments of a plurality of predetermined respective games;
maintaining a price information storage unit storing purchase price information of the ticket for participating in the tournament;
requesting, when a new user registration request command for using the tournament game service is received from a first electronic terminal of a first user, transmission of identification information for identifying the first user to the first electronic terminal, and generating, when first user identification information is received from the first electronic terminal, a first NFT including the first user identification information as owner information;
registering and processing, when the first NFT is generated, the first NFT in a predetermined blockchain network for registering the NFT, and completing issuing the first NFT to complete new user registration;
generating, when issuing the first NFT is completed, a registration completion message indicating that issuing the first NFT is completed and at the same time, indicating that the new user registration is completed, and transmitting the registration completion message to the first electronic terminal;
requesting, upon receiving the purchase request command of requesting purchasing tickets as many as a first purchase quantity from the first electronic terminal after the issuance of the first NFT is completed, transmission of payment means information to the first electronic terminal, and calculating, upon receiving first payment means information from the first electronic terminal, a price corresponding to the first purchase quantity based on the purchase price information stored in the price information storage unit, and then performing payment processing for the calculated price based on the first payment means information; and
generating, when the payment processing is completed, a first transaction indicting that the first user possesses tickets of the first purchase quantity, and registering and processing the first transaction in the blockchain network to process the first purchase quantity to be recorded in the first NFT registered in the blockchain network as information on a ticket holding quantity of the first user.
